(19) United States
(12) Patent Application Publication
(10) Pub. No.: US 2023/0336104 A1
(43) Pub. Date: Oct. 19, 2023

(54) OVERCURRENT PROTECTION CIRCUIT, CONTROL DEVICE, REMOTE ELECTRICAL TILT SYSTEM AND BASE STATION ANTENNA

(71) Applicant: CommScope Technologies LLC, Hickory, NC (US)

(72) Inventor: ManKun Li, Suzhou (CN)

(21) Appl. No.: 18/135,852

(22) Filed: Apr. 18, 2023

(30) Foreign Application Priority Data
Apr. 19, 2022 (CN) 202210408796.9

(51) Int. Cl. H02P 29/024; H01Q 3/00; H01Q 1/24; H02P 27/08; H02K 11/33

(52) U.S. Cl. CPC H02P 29/027; H01Q 3/005; H01Q 1/246; H02P 27/08; H02K 11/33

(57) ABSTRACT

An overcurrent protection circuit for a motor, where the overcurrent protection circuit includes: a first input configured to receive a first drive signal for the motor; a second input configured to receive an adjustable overcurrent protection threshold; a third input configured to receive a current detection value indicative of an amount of current flowing through the motor; an overcurrent detection module, which is configured to: connect to the second input to obtain a first comparison value related to the overcurrent protection threshold; connect to the third input to obtain a second comparison value related to the detection value; and compare the first comparison value to the second comparison value to generate a comparison output that characterizes the presence or absence of an overcurrent state.

### CROSS-REFERENCE TO RELATED APPLICATION

The present application claims the benefit of priority to Chinese Patent Application No. 202210408796.9, filed on Apr. 19, 2022, and the entire contents of the above-identified application are incorporated by reference as if set forth herein.

### TECHNICAL FIELD

The present disclosure generally relates to motor drive circuits and, more specifically, to overcurrent protection circuits for a motor and related control devices, remote electrical tilt system sand base station antennas.

### BACKGROUND

Cellular communications systems are well known in the art. In a cellular communications system, a geographic area is divided into a series of sections that are referred to as “cells” which are served by respective base stations. The base station may include one or more base station antennas that are configured to provide two-way radio frequency (“RF”) communications with mobile subscribers that are within the cell served by the base station.

Remote electrical tilt (RET) antennas are widely used as a base station antenna in cellular communication systems. Before the introduction of RET antennas, technicians had to physically climb up the antenna tower where conventional base station antennas were installed and manually adjust the mechanical mounting angle of the antennas in order to adjust the coverage area of the antennas. In general, the coverage area of the antenna is adjusted by changing the so-called “downtilt angle” of the antenna. This angle is the angle in the elevation plane where the visual axis of the antenna beam generated by the antenna directionally points. The introduction of RET antennas allows cellular operators to electrically adjust the downtilt angle of the antenna beam by sending control signals to the antennas.

A RET antenna refers to an antenna that includes a RET system. A RET system allows cellular operators to adjust the downtilt angle of the antenna beam dynamically. The RET system usually comprises a control device, a motor, a transmission mechanism, and a phase shifter for each radiating element array. The phase shifter includes a fixed element and a movable element. The control device controls the operation of the motor. The movement generated by the motor is transmitted by the transmission mechanism and converted into the movement of the movable element of the phase shifter relative to the fixed element, thereby changing the phases of respective sub-components of an RF signal that are transmitted through different sub-arrays of one or more radiating elements of the array, thus realizing adjustment of the electrical tilt of the antenna beam.

During RET operation, for example, during the motor start-up phase, in order to prevent an in-rush current from causing an impact on the drive motor and/or drive circuit, an overcurrent protection circuit is usually provided to control the in-rush current within a reasonable threshold.

However, conventional overcurrent protection measures generally rely on overcurrent protection devices that are integrated in the drive unit of the motor that cut off the drive current flowing through the motor completely during a set overcurrent protection period, thereby causing the drive torque to no longer be provided on the motor shaft and thus causing the rotational speed of the motor to drop drastically. Large fluctuations in the rotational speed of the motor may affect the stability and accuracy of the RET operation and eventually negatively affect the RET performance of the base station antenna. This is undesirable.

In addition, these conventional overcurrent protection measures generally also have a single response mode for the various run modes of the RET operation, which is also undesirable.

### SUMMARY

Therefore, among the objectives of the present disclosure is to provide an overcurrent protection circuit for a motor that is capable of overcoming at least one drawback in the prior art, as well as a related control device, RET system, and base station antenna.

According to some aspects of the present disclosure, an overcurrent protection circuit for a motor is provided. The overcurrent protection circuit may include: a first input configured to receive a first drive signal for the motor; a second input configured to receive an adjustable overcurrent protection threshold; a third input configured to receive a detection value characterizing the current flowing through the motor; an overcurrent detection module, which is configured to: connect to the second input to obtain a first comparison value related to the overcurrent protection threshold; connect to the third input to obtain a second comparison value related to the detection value; and compare the first comparison value to the second comparison value to generate a comparison output that characterizes the presence or absence of the overcurrent state; an output, which is configured to output a second drive signal that is adjusted relative to the first drive signal when in an overcurrent state to drive the motor according to the second drive signal; and a locking module, which is configured to lock the comparison output of the overcurrent detection module for a predetermined period to time in an overcurrent state, thereby locking the level state of the second drive signal.

According to some aspect of the present disclosure, a control device for a motor is provided. The control device may include a control unit, an overcurrent protection circuit according to present disclosure and a drive unit for driving the motor, in which, the control unit is configured to: provide the first drive signal for the motor to the first input of the overcurrent protection circuit, and provide the adjustable overcurrent protection threshold to the second input of the overcurrent protection circuit; in which, the drive unit is configured to: provide the detection value which characterizes the current flowing through the motor to the third input of the overcurrent protection circuit and receive the second drive signal from the output of the overcurrent protection circuit to drive the motor according to the second drive signal.

According to some aspects of the present disclosure, a RET system for a base station antenna is provided. The RET system may include: a phase shifter; a motor for driving a phase shifter rod; and the control device according to present disclosure for controlling the motor.

According to some aspects of the present disclosure, a base station antenna is provided, comprising a phase shifter and the RET system according to present disclosure.

According to some aspects of the present disclosure, a method of operating a RET system is provided, the method comprising: supplying a first drive signal to a motor of the RET system; detecting that a current supplied to the motor exceeds an overcurrent protection threshold; supplying a second drive signal to the motor in response to detecting that a current supplied to the motor exceeds an overcurrent protection threshold, wherein a level of the second drive signal is less than a level of the first drive signal.

The present disclosure will be explained in greater detail by means of specific embodiments with reference to the attached drawings. The schematic drawings are briefly described as follows:

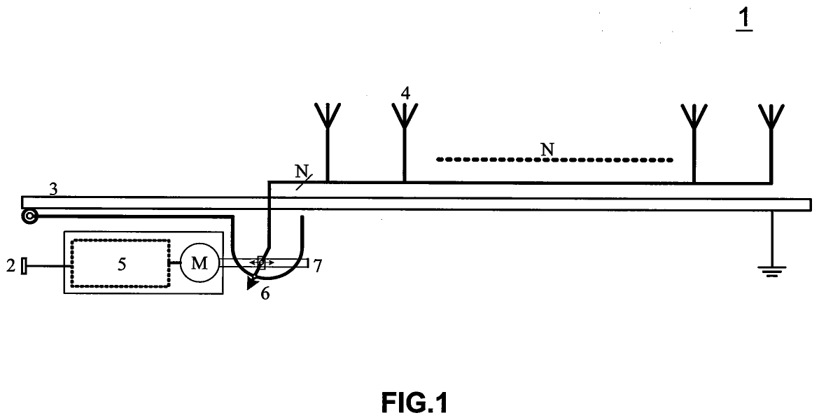

FIG. 1 is a schematic diagram of a base station antenna according to some embodiments of the present disclosure;

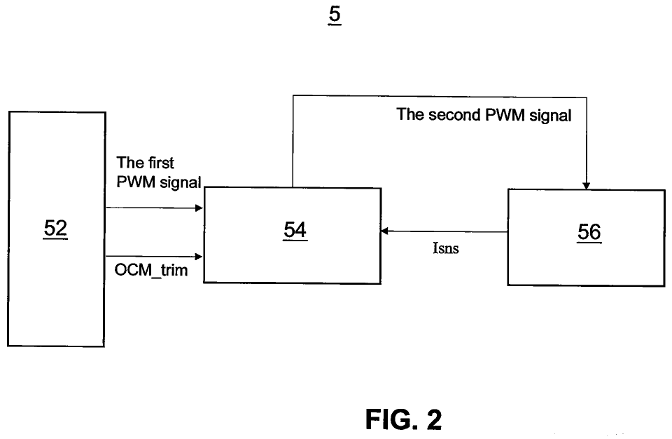

FIG. 2 is a schematic block diagram of a control device in an RET system included in the base station antenna shown in FIG. 1;

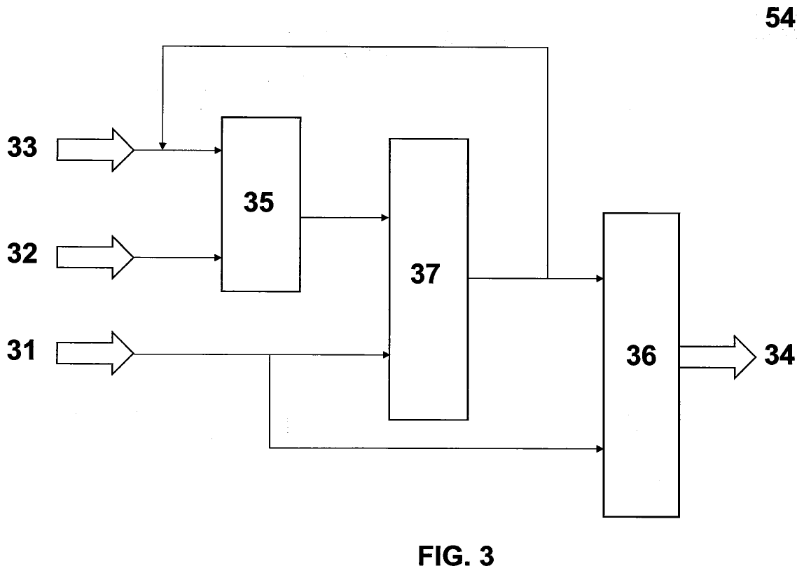

FIG. 3 is a schematic simplified block diagram of an overcurrent protection circuit in the control device shown in FIG. 2;

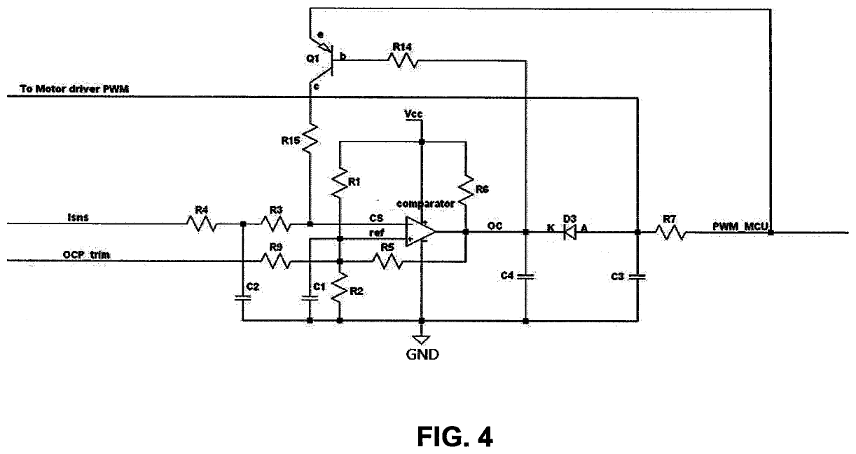

FIG. 4 is a circuit diagram of the overcurrent protection circuit shown in FIG. 3;

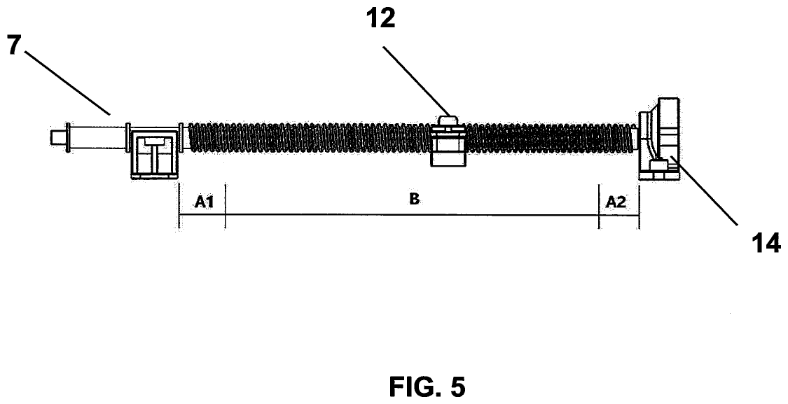

FIG. 5 is a schematic diagram of a phase shifter rod assembly, and exemplarily shows the application scenario of an adjustable overcurrent protection threshold.

### DETAILED DESCRIPTION

The present disclosure will be described below with reference to the attached drawings, wherein the attached drawings illustrate certain embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that the terms used herein are only used to describe specific embodiments, and are not intended to limit the scope of the present disclosure. All terms used herein (including technical terms and scientific terms) have meanings normally understood by those skilled in the art unless otherwise defined. For brevity and/or clarity, well-known functions or structures may not be further described in detail.

As used herein, when an element is said to be “on” another element, “attached” to another element, “connected” to another element, “coupled” to another element, or “in contact with” another element, etc., the element may be directly on another element, attached to another element, connected to another element, coupled to another element, or in contact with another element, or an intermediate element may be present. In contrast, if an element is described as “directly” “on” another element, “directly attached” to another element, “directly connected” to another element, “directly coupled” to another element or “directly in contact with” another element, there will be no intermediate elements. As used herein, when one feature is arranged “adjacent” to another feature, it may mean that one feature has a part overlapping with the adjacent feature or a part located above or below the adjacent feature.

As used herein, spatial relationship terms such as “upper,” “lower,” “left,” “right,” “front,” “back,” “high,” and “low” can explain the relationship between one feature and another in the drawings. It should be understood that, in addition to the orientations shown in the attached drawings, the terms expressing spatial relations also comprise different orientations of a device in use or operation. For example, when a device in the attached drawings rotates reversely, the features originally described as being “below” other features now can be described as being “above” the other features. The device may also be oriented by other means (rotated by 90 degrees or at other locations), and at this time, a relative spatial relation will be explained accordingly.

As used herein, the term “A or B” comprises “A and B” and “A or B,” not exclusively “A” or “B,” unless otherwise specified.

As used herein, the term “schematic” or “exemplary” means “serving as an example, instance or explanation,” not as a “model” to be accurately copied. Any realization method described exemplarily herein may not be necessarily interpreted as being preferable or advantageous over other realization methods. Furthermore, the present disclosure is not limited by any expressed or implied theory given in the above technical field, background art, summary of the invention or embodiments.

As used herein, the word “basically” means including any minor changes caused by design or manufacturing defects, device or component tolerances, environmental influences, and/or other factors.

As used herein, the term “at least part” may be a part of any proportion. For example, it may be greater than 10%, 20%, 30%, 40%, 50%, 60%, 70%, 80%, 90%, or may even be 100%.

In addition, for reference purposes only, “first,” “second” and similar terms may also be used herein, and thus are not intended to be limitative. For example, unless the context clearly indicates, the words “first,” “second” and other such numerical words involving structures or elements do not imply a sequence or order.

It should also be understood that when the term “comprise/include” is used herein, it indicates the presence of the specified feature, entirety, step, operation, unit and/or component, but does not exclude the presence or addition of one or a plurality of other features, steps, operations, units and/or components and/or combinations thereof.

The present disclosure is directed to an overcurrent protection strategy for a motor. This overcurrent protection strategy provides adaptive adjustable overcurrent protection measures for different working conditions, thereby improving the matching degree between the run mode and the actual working condition of the motor. In addition, the overcurrent protection strategy proposed by the present disclosure is capable of improving the stability of the motor during overcurrent protection.

The overcurrent protection strategy according to some embodiments of the present disclosure is described in detail below using a base station antenna as an example. It should be understood that the overcurrent protection strategy for motors proposed by the present disclosure may be applied to a variety of technical fields that require the use of motors, for example, the fields of automated production and vehicles, etc. In addition, the overcurrent protection measure for motors proposed by the present disclosure may also be extended to other types of electrical actuators, for example, electric heaters, etc.

Embodiments of the present disclosure are now described in greater detail with reference to the accompanying drawings.

FIG. 1 is a schematic diagram of a base station antenna 1 according to some embodiments of the present disclosure. The base station antenna 1 may include a reflector plate 3, which may comprise a metal surface that serves as a ground plane and reflects electromagnetic radiation reaching the reflector plate so that the electromagnetic radiation may be redirected to propagate, for example, forwardly. The base station antenna 1 may comprise a feeder panel arranged at a front side of the reflector plate 3 and a linear or planar phased array of radiating elements 4 mounted on the feeder panel.

The base station antenna 1 may further comprise additional mechanical and electronic components arranged at the rear side of the reflector plate 3, for example, connectors, cables, phase shifters 6, a RET system for phase shifters, etc.

The RET system allows cellular operators to adjust dynamically the downtilt angle of the antenna beams generated by the radiating element arrays. The RET system may comprise a control device 5, a motor M, a transmission mechanism (comprising a phase shifter rod 7) and a phase shifter 6 (for example, a rotating brush arm phase shifter) for each radiating element array. The control device 5 may receive RET control signals from a remote location via a control interface 2, and may generate a drive signal based on the received RET control signal to drive the motor M, and may then realize the phase shifting operation of the phase shifter through the transmission mechanism 7. Each phase shifter 6 may comprise a fixed element (for example, a printed circuit board printed with a phase shift circuit), a movable element (for example, a slider) and a driving member (for example, a slider linkage). Each phase shifter may also include a power divider circuit that splits RF signals input to the phase shifter (for signals transmitted by the base station antenna) into a plurality of sub-components. The driving member may be capable of converting (or configured to convert) the movement generated by the motor and transmitted by the transmission mechanism into the movement of the movable element of the phase shifter relative to the fixed element. The movement of the movable element changes the phase of one or more of the sub-components of the RF signals that are transmitted through the phase shifter, thereby adjusting the electrical tilt. Therefore, the running stability and reliability of the motor are related to the phase shifting performance of the base station antenna 1.

Next, with reference to FIGS. 2 to 4, the control device 5 in a RET system according to some embodiments of the present disclosure will be described in greater detail.

FIG. 2 is a schematic block diagram of a control device in an RET system included in the base station antenna shown in FIG. 1. As shown in FIG. 2, the control device 5 may comprise a control unit 52, an overcurrent protection circuit 54 and a drive unit 56 for driving the motor M. In some embodiments, the control device 5 may be realized as a printed circuit board, and the control unit 52, the overcurrent protection circuit 54, and the drive unit 56 may be integrated thereon.

The control unit 52 may be, for example, a microcontroller, which may receive RET control signals from a remote location, and which may determine a corresponding drive signal (hereinafter referred to as a first drive signal) for the motor M based on the RET control signal. In contrast to conventional overcurrent protection measures, the control unit 52 first transmits the first drive signal to the overcurrent protection circuit 54, and then transmits a second drive signal to the drive unit 56 through the overcurrent protection circuit 54. In the event of an overcurrent event, the overcurrent protection circuit 54 may transmit the second drive signal that has been adjusted relative to the first drive signal to the drive unit 56.

The drive unit 56 may drive the motor M according to the adjusted second drive signal. The drive unit 56, for example, may be configured as a special drive chip for the motor. The drive unit 56 may comprise a feeding power supply and a switching bridge connected between the feeding power supply and the motor, for example, a semiconductor switching bridge (the internal structure of the drive unit is not shown in the figure). In some embodiments, the motor may be a DC motor or an AC motor. In some embodiments, the motor may be a brushed DC motor, and the switching bridge may be an H-bridge circuit. In some embodiments, the switching bridge may be a full bridge circuit. In some embodiments, the switching bridge may be a half bridge circuit. In some embodiments, the switching bridge may be configured as an inverter to drive the AC motor. Each switch in the switching bridge may be turned on or disconnected under the control of a corresponding second drive signal to control the feeding of the feeding power supply to the motor according to the second drive signal.

In some embodiments, the first drive signal may be configured as a first PWM signal, and the second drive signal may be configured as a second PWM signal. PWM stands for pulse width modulation. By adjusting the duty cycle of the PWM signal, the pulse width can be adjusted, thereby adjusting the equivalent voltage value delivered to the DC motor. By adjusting the duty ratio of the second PWM signal relative to the first PWM signal, the following can be done effectively: changing the running of the motor, adjusting the power consumption, and preventing overcurrent events.

In order to prevent an overcurrent event from damaging the drive unit 56 and/or the motor M, an additional overcurrent protection circuit may be integrated into the drive unit 56 to provide overcurrent protection for detected overcurrent events. In order to detect overcurrent events, the additional overcurrent protection circuit may have a detection resistor, and the voltage value on the detection resistor may be used to determine the value of the current passing through a feed line or the motor. Overcurrent protection measures may be triggered when the voltage value on the detection resistor is greater than the predetermined protection threshold. The additional overcurrent protection circuit included in the drive unit 56 may disconnect the feed power supply from the motor via the switching bridge during the shutdown time interval predetermined by the fault timer, thereby rapidly reducing the current flowing through the feed line or motor.

However, it is not ideal to rely solely on the overcurrent protection measures of the drive unit 56. The rapid decline in current may lead to greater fluctuations in the rotational speed of the motor, thereby negatively affecting the stability and accuracy of RET operation. Additionally, various corresponding overcurrent protection modes are required for various run modes of the RET operation and/or various working conditions of the base station antenna 1.

The RET system of the present disclosure solves at least one of the above technical problems by providing an independent overcurrent protection circuit 54. As shown in FIG. 2, in addition to the first drive signal, the control unit 52 is further configured to provide the adjustable overcurrent protection threshold OCP_trim to the overcurrent protection circuit 54. The adjustable overcurrent protection threshold OCP_trim is a variable value and not a constant overcurrent protection threshold. The overcurrent protection threshold OCP_trim may have different values based on the run mode of the RET operation and/or various working conditions of the base station antenna 1. As discussed above, the drive unit 56 may provide a detection value Isns that characterizes the current passing through the motor to the overcurrent protection circuit 54. Stated differently, the detection value Isns may indicate an amount of current flowing through the motor to the overcurrent protection circuit 54. The detection value Isns may be a voltage value on the detection resistor. The overcurrent protection circuit 54 may determine whether an overcurrent event has occurred based on the received adjustable overcurrent protection threshold OCP_trim and the detection value Isns.

In some embodiments, the overcurrent protection threshold may be related to the ambient temperature. For example, when the ambient temperature is lower than a predetermined temperature threshold, a higher overcurrent protection threshold may be used, and when the ambient temperature is higher than the predetermined temperature threshold, a lower overcurrent protection threshold may be used. By setting a higher overcurrent protection threshold, the motor may be capable of outputting (or enabled to output) a greater driving force to overcome additional friction resistance caused by low temperature in the transmission mechanism.

In order to obtain the ambient temperature, in some embodiments the RET system may also comprise a temperature sensor so as to detect the current ambient temperature of the base station antenna 1 in real time. It should be understood that the overcurrent protection threshold may be related to ambient humidity and/or wind speed. Accordingly, in some embodiments the RET system may also comprise a humidity sensor and/or a wind speed sensor. It will also be understood that the information regarding the ambient temperature, ambient humidity, and/or wind speed additionally or alternatively be provided to the RET system from an external source.

In some embodiments, the overcurrent protection threshold OCP_trim may be related to the run phase or selected phase of the phase shifter 6. FIG. 5 exemplarily shows an application scenario of the adjustable overcurrent protection threshold OCP_trim. In the illustrated embodiment, the overcurrent protection threshold may be related to the position of a nut 12 (or slider or other moving element) on a phase shifter rod 7. When the nut 12 is in the end regions A1 and A2 of the phase shifter rod 7, a lower overcurrent protection threshold may be used, and when the nut 12 is in the middle region B of the phase shifter rod 7, a higher overcurrent protection threshold may be used. That is to say, different overdrive current levels are switched or selected depending on the position of the nut or other movable element. The lower overcurrent protection threshold may permit a lower drive current to be supplied to the motor, and once the drive current exceeds the lower overcurrent protection threshold, an overcurrent event will be detected and the drive current will be further reduced. The lower overcurrent protection threshold may keep the motor drive current in a relatively low value in the end regions A1 and A2, thereby reducing the rotational speed of the motor in the end regions A1 and A2, and reducing the impact on the hindrance mechanism 14 during the movement of the nut 12 to the end regions A1 and A2. The higher overcurrent protection threshold may permit a higher drive current to be supplied to the motor, and once the drive current exceeds the higher overcurrent protection threshold, an overcurrent event will be detected and the drive current will be further reduced. The higher overcurrent protection threshold may keep the motor drive current in a relatively high value in the middle region B, thereby increasing the rotational speed of the motor in the middle region B, and accelerating the phase shifting process and increasing RET efficiency.

Accordingly, the RET system may comprise a nut position detection device so as to detect the position of the nut 12 on the phase shifter rod 7 in real time.

Next, the design scheme of the overcurrent protection circuit 54 of some embodiments of the present disclosure will be described in greater detail. FIG. 3 is a schematic simplified block diagram of the overcurrent protection circuit 54; and FIG. 4 is a circuit diagram of one example implementation of the overcurrent protection circuit 54.

As shown in FIG. 3, the overcurrent protection circuit 54 may comprise a first input 31 which is configured to receive a first drive signal for the motor; a second input 32 which is configured to receive an adjustable overcurrent protection threshold OCP_trim; and a third input 33 which is configured to receive a detection value Isns which characterizes or indicates the current flowing through the motor (or an amount of current flowing through the motor). The overcurrent protection circuit 54 may comprise an output 34 which is configured to output a second drive signal that is adjusted relative to the first drive signal in an overcurrent state. That is to say, the overcurrent protection circuit 54 may be configured to generate a corresponding second drive signal based on (a) the received first drive signal, (b) the overcurrent protection threshold and (c) the detection value Isns, and then transmit the second drive signal to the drive unit 56 for driving the motor according to the second drive signal during an overcurrent protection event.

The overcurrent protection circuit 54 may include an overcurrent detection module 35 that is used to detect the overcurrent event based on the overcurrent protection threshold and detection value Isns. The overcurrent detection module 35 may comprise a first terminal, a second terminal and a third terminal. The first terminal may be connected to the second input 32 of the overcurrent protection circuit 54 to obtain a first comparison value related to the overcurrent protection threshold. The second terminal may be connected to the third input 33 of the overcurrent protection circuit 54 to obtain a second comparison value related to the detection value Isns. The overcurrent detection module 35 may compare the first comparison value with the second comparison value and generate a comparison output. The comparison output may be output through the third terminal of the overcurrent detection module 35. The comparison output may have different levels, and the presence or absence of the overcurrent state may be indicated by the different levels. In some embodiments, when the comparison output is at a low level, it may indicate that the second comparison value is greater than or equal to the first comparison value, i.e., an overcurrent event has occurred; otherwise, when the comparison output is at a high level, it is indicative that no overcurrent event has occurred.

In some embodiments, the first terminal of the overcurrent detection module 35 may be directly connected to the second input 32 of the overcurrent protection circuit 54. In such embodiments, the first comparison value may be basically equal to the overcurrent protection threshold.

In some embodiments, the first terminal of the overcurrent detection module 35 may be indirectly connected to the second input 32 of the overcurrent protection circuit 54 via intermediate circuits such as filter circuit, bleeder circuit and/or bias circuit. In these embodiments, the first comparison value may be different from the overcurrent protection threshold but may be proportional to it.

In some embodiments, the second terminal of the overcurrent detection module 35 may be directly connected to the third input 33 of the overcurrent protection circuit 54. In these embodiments, the second comparison value may be basically equal to the detection value Isns.

In some embodiments, the second terminal of the overcurrent detection module 35 may be indirectly connected to the third input 33 of the overcurrent protection circuit 54 via intermediate circuits such as filter circuit and/or bleeder circuit. In these embodiments, the second comparison value may be different from the detection value Isns but may be proportional to it. In some cases, since the detection value Isns is easily mixed with undesirable noise, it may be filtered into a smooth detection value Isns through a filter circuit. This is conducive to the reliable and accurate detection results of the overcurrent detection module 35.

As shown in FIG. 4, the overcurrent detection module 35 may include a comparator. The second input 32 of the overcurrent protection circuit 54 may be connected to a first comparison input ref (front input port) of the comparator. In the depicted embodiment, the second input 32 of the overcurrent protection circuit 54 may be connected to the first comparison input ref via the voltage bias and/or divider circuit and the input resistor R9 to transmit the first comparison value related to the adjustable overcurrent protection threshold OCP_trim to the comparator. The voltage bias and/or divider circuit may comprise a first dividing resistor R1 and a second dividing resistor R2. The first dividing resistor R1 is connected between the DC supply Vcc and the first comparison input ref. The second dividing resistor R2 is connected between the first comparison input ref and the ground GND. In addition, it can be seen from FIG. 4 that the overcurrent detection module 35 comprises a feedback resistor R5, and the feedback resistor R5 is connected between the output OC of the comparator and the first comparison input ref to form a feedback loop.

The third input 33 of the overcurrent protection circuit 54 is connected to a second comparison input cs (negative input port) of the comparator. In the depicted embodiment, the third input 33 of the overcurrent protection circuit 54 may be connected to the second comparison input cs via the RC filter circuit composed of a resistor R4 and capacitor C2, and the input resistor R3, so as to transmit the denoised detection value Isns, i.e., the second comparison value, to the second comparison input cs of the comparator.

The comparator may be configured to: (1) confirm that there is no overcurrent event and output a high level when the second comparison value is less than the first comparison value and (2) confirm that an overcurrent event has occurred, output a low level and trigger overcurrent protection measures accordingly when the second comparison value is greater than or equal to the first comparison value.

As shown in FIG. 3, the overcurrent protection circuit 54 may comprise a unidirectional conduction circuit 36. An output OC of the overcurrent detection module 35 may be input into the unidirectional conduction circuit 36, and the first input 31 of the overcurrent protection circuit 54 (the first drive signal) may be input into the unidirectional conduction circuit 36. The unidirectional conduction circuit 36 maybe output to the output 34 of the overcurrent protection circuit 54.

As shown in FIG. 4, the unidirectional conduction circuit 36 may comprise a diode D3, for example, a Schottky diode. The output OC of the comparator may be connected to the anode K of the diode D3. On one hand, a cathode A of a diode D3 is connected to the output 34 of the overcurrent protection circuit 54, and on the other hand, it is connected to the first input 31 of the overcurrent protection circuit 54 via a resistor R7.

The diode D3 may conduct under the following conditions, i.e., when the comparator outputs a low level (due to an overcurrent event) and the first PWM signal (PWM_MCU) is in the high level period. Through the conduction of the diode, the level of the second PWM signal (To Motor driver PWM) on the output 34 of the overcurrent protection circuit 54 is clamped at a low level, which may be basically equal to the conduction voltage drop of the diode D3. For example, the conduction voltage drop of the Schottky diode may be 0.15-0.5 V.

The diode D3 does not conduct under the following conditions, i.e. when the comparator outputs a high level and/or the first PWM signal is in the low level period. At this time, the second PWM signal is basically equal to the first PWM signal.

Based on the above analysis, when an overcurrent event occurs, the second PWM signal is lower than the first PWM signal in terms of the duty ratio, thereby limiting the current flowing through the motor and thus eliminating the overcurrent event.

However, in some embodiments and situations, it may be undesirable and/or non-ideal to implement overcurrent protection measures solely based on the overcurrent detection module 35 because the implementation of this overcurrent protection measure strictly depends on the comparison of the second comparison value with the first comparison value. Once the second comparison value is greater than or equal to the first comparison value, overcurrent protection measures will be triggered immediately, and the second PWM signal is maintained at a low level to reduce the current. Once the second comparison value is less than the first comparison value, the overcurrent protection measure will be cancelled immediately. Therefore, the following undesirable phenomena may occur: overcurrent protection measures are frequently triggered and cancelled, and the switch in the drive unit 56 is frequently turned on/off, thereby introducing undesirable noise interference and accelerating damage to the drive unit 56 and/or the motor.

Therefore, as shown in FIG. 3, the overcurrent protection circuit 54 of the present disclosure further introduces a locking module 37, which may receive a comparison output and a first drive signal of the overcurrent detection module 35 and which may be configured perform locking operations according to the comparison output OC and the first drive signal. The locking module 37 may be configured to: lock the second comparison value of the overcurrent detection module 35 in dependence of the level state of the first drive signal (i.e. first PWM signal) in an overcurrent state, thereby locking the comparison output OC of the overcurrent detection module 35, so as to lock the level state of the second drive signal, thereby avoiding the aforementioned undesirable phenomenon.

In some embodiments, the locking module 37 may be configured to: in every PWM signal cycle (since in some embodiments the first PWM signal and the second PWM signal may have the same signal cycle), lock the second PWM signal at a low level when the first PWM signal is in the high level period in an overcurrent state, regardless of whether the second comparison value is greater or smaller than the first comparison value; maintain the second PWM signal at a low level when the first PWM signal is in the low level period. Therefore, the locking module 37 is capable of stabilizing the waveform of the second PWM signal according to the first PWM signal, overcurrent protection threshold and detection value Isns, thereby stabilizing operation of the motor.

As shown in FIG. 4, the locking module 37 may comprise a transistor Q1 that has a base b that is connected to the output OC of the comparator via an input resistor R14. The emitter e of the transistor Q1 may be connected to the first input 31 and thus be connected to the first PWM signal. In addition, the collector c of the transistor Q1 may be connected to the second comparison input cs of the comparator via an output resistor R15.

The locking module 37 may be configured to: form an enhanced feedback loop when the transistor Q1 conducts and the enhanced feedback loop is configured to lock the second comparison value of the second comparison input cs of the comparator so as to lock the comparison output OC. In the current embodiment, the transistor Q1 may be configured as a PNP transistor Q1. When the base b is at a low level and the emitter e is at a high level, the transistor Q1 conducts. That is to say, in each PWM signal cycle, when the comparison output is at a low level (due to the overcurrent event) and the first PWM signal is in the high level period, the transistor Q1 conducts. Once the transistor Q1 conducts, the second comparison value of the second comparison input cs is locked to a high level greater than the first comparison value, thereby the comparison output is locked to a low level.

It should be understood that those skilled in the art may use other types of transistors by adjusting the topological structure, for example, NPN transistors or MOSFET etc.

Alternatively or additionally, the overcurrent protection circuit 54 of some embodiments of the present disclosure may also comprise other devices. As shown in FIG. 4, the overcurrent detection module 35 may comprise a first regulated capacitor C1, which is connected between the first comparison input ref and the ground GND. Alternatively or additionally, the overcurrent detection module 35 may comprise a second regulated capacitor C4, which is connected between the output OC of the comparator and the ground GND. Alternatively or additionally, the overcurrent protection circuit 54 may comprise a third regulated capacitor C3, which is connected between the output 34 of the overcurrent protection circuit 54 and the ground GND.

Although exemplary embodiments of the present disclosure have been described, those skilled in the art should understand that many variations and modifications are possible in the exemplary embodiments without materially departing from the spirit and scope of the present disclosure. Therefore, all variations and changes are included in the protection scope of the present disclosure defined by the claims. The present disclosure is defined by the attached claims, and equivalents of these claims are also included.

1. An overcurrent protection circuit for a motor, wherein the overcurrent protection circuit comprises:
a first input configured to receive a first drive signal for the motor;
a second input configured to receive an adjustable overcurrent protection threshold;
a third input configured to receive a current detection value indicative of an amount of current flowing through the motor;
an overcurrent detection module configured to: connect to the second input to obtain a first comparison value related to the adjustable overcurrent protection threshold; connect to the third input to obtain a second comparison value related to the current detection value; and compare the first comparison value to the second comparison value and generate a comparison output indicating a presence or an absence of an overcurrent state;
an output, which is configured to output a second drive signal that drives the motor, wherein the second drive signal is adjusted relative to the first drive signal when the overcurrent state is present; and
a locking module, which is configured to lock the comparison output of the overcurrent detection module for a predetermined period of time when the overcurrent state is present, thereby locking a level state of the second drive signal.

2. The overcurrent protection circuit according to claim 1, wherein the overcurrent detection module comprises a comparator, where a first comparison input is connected to the second input of the overcurrent protection circuit to obtain the first comparison value, a second comparison input is connected to the third input of the overcurrent protection circuit to obtain the second comparison value, and the output of the comparator is configured as the comparison output.

3. The overcurrent protection circuit according to claim 2, wherein the first comparison input of the comparator is a positive comparison input, and the second comparison input of the comparator is a negative comparison input.

4. The overcurrent protection circuit according to claim 1, wherein the overcurrent detection module is configured to:
confirm the presence of the overcurrent state and that the comparison output is at a low level when the second comparison value is greater or equal to the first comparison value; and
confirm the absence of the overcurrent state and that the comparison output is at a high level when the second comparison value is smaller than the first comparison value.

5. The overcurrent protection circuit according to claim 2, wherein the locking module comprises a transistor, where a first terminal of the transistor is connected with the output of the comparator, a second terminal of the transistor is connected to the first input to obtain the first drive signal, and a third terminal of the transistor is connected to the second comparison input of the comparator.

6. The overcurrent protection circuit according to claim 5, wherein the first terminal of the transistor is a base of the transistor, the second terminal of the transistor is an emitter of the transistor and the third terminal of the transistor is a collector of the transistor.

7. The overcurrent protection circuit according to claim 5, wherein the locking module comprises an input resistor which is connected between the output of the comparator and the first terminal of the transistor, and the locking module comprises an output resistor which is connected between the third terminal of the transistor and the second comparison input of the comparator.

8. The overcurrent protection circuit according to claim 5, wherein the locking module is configured to form an enhanced feedback loop when the transistor conducts and the enhanced feedback loop is configured to lock the second comparison value of the second comparison input of the comparator so as to lock the comparison output, and wherein the transistor is configured to conduct in an overcurrent state and when the first drive signal is at a high level.

9. The overcurrent protection circuit according to claim 1, wherein the overcurrent protection circuit comprises a unidirectional conduction circuit, which comprises a diode, where a cathode of the diode is connected to the first input of the overcurrent protection circuit via a resistor, and is also connected to the output of the overcurrent protection circuit, and an anode of the diode is connected to the comparison output of the overcurrent detection module.

10. (canceled)

11. The overcurrent protection circuit according to claim 9, wherein the first drive signal is a first pulse width modulation (PWM) signal and the second drive signal is a second PWM signal.

12. The overcurrent protection circuit according to claim 11, wherein the locking module is configured to: lock the comparison output of the overcurrent detection module based on a level state of the first PWM signal in an overcurrent state, thereby locking a level state of the second PWM signal, wherein the locking module is configured to: in every PWM signal cycle, lock the second PWM signal at a first low level when the first PWM signal is in a high level period in an overcurrent state.

13-25. (canceled)

26. A control device for a motor, wherein the control device comprises a control unit, the overcurrent protection circuit according to claim 1 and a drive unit configured to drive the motor,
wherein the control unit is configured to: provide the first drive signal for the motor to the first input of the overcurrent protection circuit, and provide the adjustable overcurrent protection threshold to the second input of the overcurrent protection circuit; and
wherein the drive unit is configured to: provide the current detection value to the third input of the overcurrent protection circuit and receive the second drive signal from the output of the overcurrent protection circuit to drive the motor according to the second drive signal.

27. The control device according to claim 26, wherein the control unit is configured to receive a plurality of overcurrent protection thresholds, in which, a first overcurrent protection threshold is assigned to a first working condition, and a second overcurrent protection threshold is assigned to a second working condition.

28. The control device according to claim 27, wherein the control unit is configured to receive a working condition detection parameter so as to determine whether it is the first or second working condition according to the working condition detection parameter.

29. The control device according to claim 27, wherein the drive unit comprises a feeding power supply and a switching bridge connected between the feeding power supply and the motor, where the switching bridge is controlled by the second drive signal and configured to control feeding of the feeding power supply to the motor according to the second drive signal.

30-32. (canceled)

33. A RET system for a base station antenna, comprising:
a phase shifter;
a motor configured to drive a phase shifter rod coupled to the phase shifter; and
the control device according to claim 26 and configured to control the motor.

34. The RET system according to claim 33, wherein the RET system comprises a position detection device configured to detect a position of a nut on the phase shifter rod, and the control device is configured to: use a corresponding overcurrent protection threshold according to the position of the nut on the phase shifter rod.

35. The RET system according to claim 34, wherein the control device is configured to: use a first overcurrent protection threshold when the nut is in a first end region or a second end region of the phase shifter rod, and use a second overcurrent protection threshold when the nut is in a middle region of the phase shifter rod between the first and second end regions, where the first overcurrent protection threshold is smaller than the second overcurrent protection threshold.

36. The RET system according to claim 33, wherein the RET system comprises a temperature sensor, a humidity sensor and/or a wind speed sensor, and wherein the control device is configured to: use the corresponding overcurrent protection threshold according to a sensed value of the temperature sensor, humidity sensor and/or wind speed sensor.

37. The RET system according to claim 36, wherein the control device is configured to: use a third overcurrent protection threshold when an ambient temperature is lower than a predetermined temperature threshold, and use a fourth overcurrent protection threshold when the ambient temperature is higher than the predetermined temperature threshold, where the third overcurrent protection threshold is higher than the fourth overcurrent protection threshold.

38-53. (canceled)
